(19) United States
(12) Patent Application Publication
(10) Pub. No.: US 2021/0002866 A1
(43) Pub. Date: Jan. 7, 2021

(54) FITTING SECURING DEVICE FOR HYDRAULIC HOSE COUPLINGS, CONSTRUCTION MACHINE, AND METHOD

(71) Applicant: BOMAG GMBH, Boppard (DE)

(72) Inventor: Werner GRINGS, Boppard (DE)

(21) Appl. No.: 16/919,192

(22) Filed: Jul. 2, 2020

(30) Foreign Application Priority Data
Jul. 2, 2019 (DE) 10 2019 004 659.5

(51) Int. Cl. E02F 9/22

(52) U.S. Cl. CPC E02F 9/2275; B60Y 2200/221; E02F 9/2271

(57) ABSTRACT

A fitting securing device for facilitated assembly and securing of hydraulic hose couplings, in particular for construction machines, with a holding device comprising a fitting receptacle for receiving a fitting of a first hose end, wherein the holding device includes an anti-rotation device which prevents rotation of the fitting of the first hose end about a flow axis in the fitting receptacle, wherein the fitting securing device includes an axial securing device which prevents displacement of the fitting of the first hose end along at least one direction of the flow axis in the fitting receptacle, and wherein the fitting receptacle penetrates the holding device such that a fitting of a second hose end can be coupled directly to the fitting of the first hose end secured in the fitting receptacle. The invention further relates to a method for assembling a fitting securing device.

### FIELD

The invention relates to a fitting securing device for facilitating the assembly and securing of hydraulic hose couplings, in particular for construction machines. Moreover, the invention also relates to a construction machine, in particular a ground or landfill compactor or a road paver, having such a fitting securing device. Finally, the invention also relates to a method for producing a hydraulic hose coupling of a construction machine.

### BACKGROUND

When assembling complex hydraulic systems, such as those typically found in construction machines, hydraulic components such as hydraulic pumps, hydraulic actuators, especially hydraulic motors and/or hydraulic cylinders, must regularly be connected to each other at various positions on the machines via hoses or pipelines, for example to connect a hydraulic pump to a hydraulic actuator in a fluid-conducting manner. This usually involves connecting machine parts which can move relative to one another during operation. This is typically the case, for example, for the front and rear carriages of articulated construction machines and/or for elements disposed on devices that are adjustable relative to a machine frame, such as a milling drum that can be lowered relative to a machine frame, a boom of an excavator, a paving screed of a road paver, a blade of a landfill or soil compactor, etc. Flexible hydraulic hoses are typically used, at least to a limited extent, to connect the hydraulic components, especially across units that are adjustable relative to one another. Due to their inherent flexibility, they are also suitable for connecting machine parts which move relative to one another.

When using such hose connections, especially flexible ones, the connection points of the respective hose to the respective hydraulic components, to another hydraulic hose, etc. are often problematic. These connection or joining points are often responsible for the occurrence of leaks, for example due to poor handling during the manufacturing process. In order to have as few potential leakage points as possible in the hydraulic system, it is therefore common to use hydraulic hoses that are as continuous as possible and thus comparatively long, which oftentimes have to be installed over long distances in or on the machine. For reasons of spatial accessibility, these are often attached to a pre-assembly unit, for example a drive or motor assembly, early in the assembly process of such a construction machine and must then be moved along with the pre-assembly unit as a bundle of heavy, only slightly flexible hydraulic hoses. As a large number of such hydraulic hoses is often required, their handling during assembly is difficult and cumbersome.

In addition, if such a long hydraulic hose is damaged or worn, the entire hose must be replaced. On the one hand, this is a challenge due to the accessibility of the corresponding connections of the hose to the hydraulic system and, on the other hand, it also increases costs since unworn parts of the long hydraulic hoses are also disposed of.

Hydraulic hoses typically have so-called fittings at their hose ends for connection or joining purposes. The term “fitting” is used here to denote a coupling, typically made of metal, at the hose end of the hydraulic hose. The fitting usually has one side where it is firmly and tightly connected to the hydraulic hose, e.g. typically pressed. Moreover, the fitting usually comprises another side that has a coupling device for a complementary fitting which may be arranged, for example, either on a hydraulic system or on another hydraulic hose. In general, the fitting thus forms the end of the hydraulic hose and offers the possibility of attaching it in a pressure-safe and tight manner to another fitting and thus connecting the two fittings such that the hydraulic fluid flows from the hydraulic hose through the two fittings into another part of the hydraulic system or another hydraulic hose. Such hydraulic hose fittings are known in the prior art.

In the prior art, so-called bulkhead plates or threaded bulkhead connections are used, for example, which represent an interface for hydraulic hoses. Bulkhead plates are designed, for example, as flat plates into which double-sided ports are inserted to each of which a hose end of a hydraulic hose can be coupled. For this purpose, the ports are provided with threads and/or nuts, for example sleeve nuts, as well as seals and, if necessary, valves, so that the bulkhead plate as a whole comprises a holding device with a fitting receptacle for receiving a fitting of the respective hose end. The ports of the bulkhead plates thus allow a hydraulic hose to be attached on both sides, for example screwed on, which are in flow connection via the port. As a result, hydraulic hose connections which would otherwise be very long can be separated into two parts, for example a first part from a hydraulic component to the bulkhead plate, and a second part from the bulkhead plate to another hydraulic component. As a result, the hydraulic hoses used are shorter and easier to handle during assembly. Moreover, worn sections can be replaced separately. The problem here, however, is that two threaded connections with the bulkhead plate are necessary, which also introduces two potential leakage points per hydraulic line into the system. Moreover, such bulkhead plates with the corresponding ports are comparatively large and therefore require a lot of installation space.

### SUMMARY

Against this background, the object of the present invention is to provide a possibility to facilitate the assembly of the hydraulic hoses of a hydraulic system. As few potential leakage points as possible should be introduced into the hydraulic system and at the same time as little installation space as possible should be used. A further object is to provide a possibility to use shorter hydraulic hoses instead of continuous long hydraulic hoses without drastically increasing the risk of leakage.

Thus, according to the invention, a fitting securing device is provided for facilitated assembly and securing of hydraulic hose couplings, in particular for construction machines, with a holding device comprising a fitting receptacle for receiving a fitting of a first hose end, wherein the holding device includes an anti-rotation device which prevents rotation of the fitting of the first hose end about a flow axis in the fitting receptacle, wherein the fitting securing device includes an axial securing device which prevents displacement of the fitting of the first hose end along at least one direction of the flow axis in the fitting receptacle, and wherein the fitting receptacle penetrates the holding device such that a fitting of a second hose end can be coupled directly to the fitting of the first hose end secured in the fitting receptacle. The flow axis here designates the axis along which a hydraulic fluid flows through the fitting securing device during operation, i.e. with connected hoses. It thus designates the intended main flow direction of the hydraulic fluid through the fitting securing device in the assembled state.

With the fitting securing device according to the invention, first and second hose ends of hydraulic hoses of a construction machine can be easily coupled together and effectively protected against axial and radial displacement. Moreover, it is not necessary to use excessively long hydraulic hoses to enable corresponding connections. This reduces costs and also improves the handling of the hydraulic systems. Due to the displacement protection in the fitting securing device in the direction of the flow axis, the fitting of the first hose end can also be held securely in the fitting securing device and, in particular, can be pre-assembled at the hose end and afterwards inserted into the fitting securing device and held there in a secured manner. The anti-rotation device makes it easier to connect the fitting of the second hose end directly to the fitting of the first hose end. Through this, the fittings of the first and second hose ends can both be pre-assembled separately from the fitting securing device and can then be connected to one another directly via the fitting securing device, so that in total only one connection point and thus only one point to be sealed is involved in the fluid-conducting connection of the two hose ends via the fitting securing device.

According to a preferred embodiment, the fitting receptacle is configured as an opening completely penetrating the holding device, and the anti-rotation device is configured as an edge delimiting this opening in a radial direction of the flow axis, said edge preferably being configured polygonal or corrugated and engaging the fitting of the first hose end in a form-locking manner at least such that a rotation of the fitting of the first hose end in the fitting receptacle is prevented, in particular mechanically blocked. Through this configuration, the hose ends are prevented from rotating about the flow axis in the fitting receptacle in a simple and cost-effective manner. This efficiently reduces the risk of a threaded connection between the first and second hose ends coming loose.

According to another preferred embodiment, the axial securing device includes an axial stop formed integrally with the holding device against which the fitting of the first hose end rests in the fitting receptacle in the assembled state and which prevents displacement of the fitting of the first hose end along a direction of the flow axis in the fitting receptacle. This ensures that the hose ends are held securely, in particular in a form-locking manner, in the fitting receptacle and cannot disengage. The axial stop is preferably configured as a constriction of an opening cross-section of the fitting receptacle along the flow axis, in particular as a projection which surrounds the fitting receptacle at least partially and preferably completely on the inside, more particularly as a projection projecting in a radial direction towards the flow axis.

According to a further preferred embodiment, the axial securing device includes a detachable axial stop against which the fitting of the first hose end rests in the fitting receptacle and which prevents displacement of the fitting of the first hose end along a direction of the flow axis in the fitting receptacle. It is thus generally possible for the axial stop to be fixed and in particular also formed integrally with the holding device. However, there are also assembly situations in which it is preferable for the axial stop to be configured as an element that can be detachably fixed to the remaining holding device. In this manner, the axial securing device can be activated, so to speak, by assembling the retaining device and deactivated by disassembling it.

Moreover, the holding device advantageously includes an axial securing device receptacle which extends continuously from an outside of the holding device into the fitting receptacle, wherein the detachable axial stop can be inserted into the axial securing device receptacle, in particular perpendicularly to the flow axis, so that the detachable axial stop at least partially engages behind a holding collar of the fitting of the first hose end located in the fitting receptacle and secures the fitting in a direction of the flow axis in a form-locking manner.

The detachable axial stop may comprise a detachable fastening element, in particular a plug-in element, more particularly a bolt, which prevents movement of the fitting of the first hose end in a direction of the flow axis in a form-locking manner.

It is also advantageous if the detachable axial stop comprises two projections with which the detachable axial stop engages around the fitting of the first hose end at least partially, in particular at least half the circumference of the fitting.

The holding device preferably includes a bore to which the detachable axial stop can be fastened with a fastening device, in particular a screw. The detachability of the axial stop facilitates the assembly or the fastening of the hose ends in the fitting receptacle.

The axial securing device receptacle may be configured as a recess in the direction of the flow axis in the holding device. A securing holder may also be provided which is attached to the holding device and holds the detachable axial stop in the axial securing device receptacle in a form-locking manner in the direction of the flow axis.

According to another preferred embodiment, two detachable axial stops are provided for the fitting of the first hose end which are in particular spaced from one another in the axial direction of the flow axis to prevent displacement in the direction of a flow direction and against the direction of this flow direction and/or to enable securing towards both sides in the radial direction. These may be, for example, two socket pins passed through bores or the like.

According to yet another preferred embodiment, the axial securing device includes both the axial stop formed integrally with the holding device and the detachable axial stop, the axial stops respectively preventing the fitting of the first hose end from being displaced along different directions of the flow axis in the fitting receptacle, so that the fitting of the first hose end is secured against displacement in both directions along the flow axis.

The holding device is preferably configured to receive and secure multiple hydraulic hose couplings simultaneously, the flow axes of the respective hydraulic hose couplings being arranged in particular parallel to one another. The features mentioned above are then preferably provided on the holding device in an appropriate multiplicity.

The fitting securing device may also comprise multiple holding devices which are configured complementary in a form-locking manner and can be fastened to one another, in particular such that the flow axes of all hydraulic hose couplings are arranged parallel to one another. In this way, connection groups can easily be combined centrally, especially in the assembly process.

A further aspect of the invention consists in a fitting securing device comprising the holding device, as described above, as well as the fitting of the first hose end with a connection point for receiving a fitting of a second hose end.

Moreover, according to the invention, a construction machine, in particular a ground or landfill compactor or a road paver, is provided which in particular includes an articulated joint and is provided with a fitting securing device as described above.

The fitting securing device is preferably part of a pre-assembly group, in particular a drive pre-assembly group. A pre-assembly group is thus a set of elements that is pre-assembled separately in the context of the assembly of a construction machine and then installed in the remaining construction machine as a whole. A drive pre-assembly group is a pre-assembly group which comprises the drive motor, which is usually a combustion engine.

According to the invention, a method for producing a hydraulic hose coupling of a construction machine, in particular a construction machine as described above, is further provided, said method comprising the following steps: Attaching a fitting to a first hose end of a first hydraulic hose, inserting the fitting of the first hose end into a fitting receptacle of a fitting securing device, securing the fitting of the first hose end against rotation in the fitting receptacle of the fitting securing device, securing the fitting of the first hose end against axial movement in the fitting receptacle of the fitting securing device with respect to a flow axis of the hydraulic hose coupling, attaching a fitting complementary to the fitting of the first hose end to a second hose end of a second hydraulic hose, and connecting the fitting of the first hose end directly to the fitting of the second hose end.

The method preferably comprises performing steps a) to d) on a first assembly group, performing step e) on a second assembly group, and connecting the first and second assembly groups by step f).

A modified embodiment of the method according to the invention finally consists in first producing a pre-assembly group comprising the fitting securing device according to the invention, then installing the pre-assembly group in the remaining construction machine, and subsequently producing at least one hose connection by connecting a second hose end, ideally with a corresponding connection fitting, to the fitting of the first hose end already fixed in the holding device.

### BRIEF DESCRIPTION OF THE DRAWINGS

The invention will be explained in more detail below by reference to the embodiment examples indicated in the figures. In the schematic figures:

FIG. 1 is a side view of a first construction machine, more specifically a single-drum roller;

FIG. 2 is a side view of a second construction machine, more specifically a landfill compactor;

FIG. 3 is a side view of a third construction machine, more specifically a road paver;

FIG. 4 shows a first assembly group and a second assembly group for carrying out the method for producing a hydraulic hose coupling of a construction machine;

FIG. 5 shows a side view (top) and a cross-sectional view (bottom) of a fitting securing device according to an embodiment of the invention;

FIG. 6 is a perspective view of the holding device of FIG. 5;

FIG. 7 is another perspective view of the holding device illustrated in FIG. 5;

FIG. 8 is yet another perspective view of the holding device illustrated in FIG. 5;

FIG. 9 is an exploded view of the fitting securing device according to FIG. 5;

FIG. 10 is a perspective view of a fitting securing device according to another embodiment;

FIG. 11 shows a cross-sectional view of a fitting securing device according to another embodiment;

FIG. 12 is a perspective view of a holding device according to the embodiment illustrated in FIG. 11;

FIG. 13 is another perspective view of the holding device illustrated in FIG. 11;

FIG. 14 is yet another perspective view of the holding device illustrated in FIG. 11;

FIG. 15 is an exploded view of the fitting securing device according to the embodiment illustrated in FIG. 11;

FIG. 16 is a perspective view of a fitting securing device according to another embodiment;

FIG. 17 shows a fitting securing device according to another embodiment of the invention;

FIG. 18 is a perspective view of a holding device according to the embodiment illustrated in FIG. 17;

FIG. 19 is another perspective view of the holding device illustrated in FIG. 17;

FIG. 20 is yet another perspective view of the holding device illustrated in FIG. 17;

FIG. 21 is an exploded view of the fitting securing device according to the embodiment illustrated in FIG. 17;

FIG. 22 is a perspective view of a fitting securing device according to another embodiment;

FIG. 23 shows a fitting securing device according to another embodiment of the invention;

FIG. 24 is a perspective view of a holding device according to the embodiment illustrated in FIG. 23;

FIG. 25 is another perspective view of the holding device illustrated in FIG. 23;

FIG. 26 is yet another perspective view of the holding device illustrated in FIG. 23;

FIG. 27 is an exploded view of the fitting securing device according to the embodiment illustrated in FIG. 23; and

FIG. 28 is a perspective view of a fitting securing device according to another embodiment.

### DETAILED DESCRIPTION

Like components or functionally like components are designated by like reference numerals in the figures. Not every component that is repeated in the figures is marked with a separate reference numeral in each of the figures.

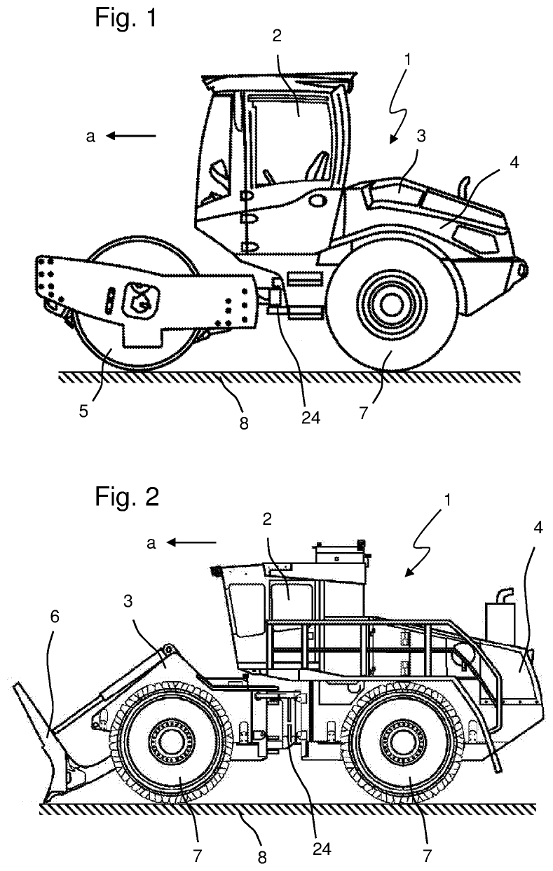

FIG. 1 shows a first construction machine 1 for ground compaction, which is in this case configured as a single-drum roller. The construction machine 1 comprises a two-part machine frame 3, wherein the front part, i.e. the part arranged at the front of the machine frame 3 with respect to the working direction a, and the rear part, i.e. the part arranged at the rear of the machine frame with respect to the working direction, are connected to each other via an articulated joint 24. Furthermore, a compaction or roller drum 5 is provided on the front part of the machine frame 3, and an operator platform 2 and a drive motor 4 via which the drive energy required for the working and traveling operation are supplied, in particular for driving the wheels 7, are provided on the rear part of the machine frame 3.

FIG. 2 shows a second construction machine 1 in the form of a landfill compactor. Again, the construction machine 1 comprises a two-part, articulated machine frame 3, wherein the front part, i.e. the part arranged at the front of the machine frame 3 with respect to the working direction a, and the rear part, i.e. the part arranged at the rear of the machine frame with respect to the working direction, are connected to each other via an articulated joint 24. Traveling devices of the traveling mechanism 7, which are in this case configured as padfoot drums, are mounted on the machine frame 3. Moreover, a liftable and lowerable blade 6 is provided on the front part of the machine frame 3. Disposed on the rear part of the machine frame 3 are an operator platform 2 and a drive motor 4 for moving the construction machine 1 on the ground 8, so that in working operation the landfill compactor 1 can maneuver in and against the forward direction a over the waste to be compacted, shredded and/or moved.

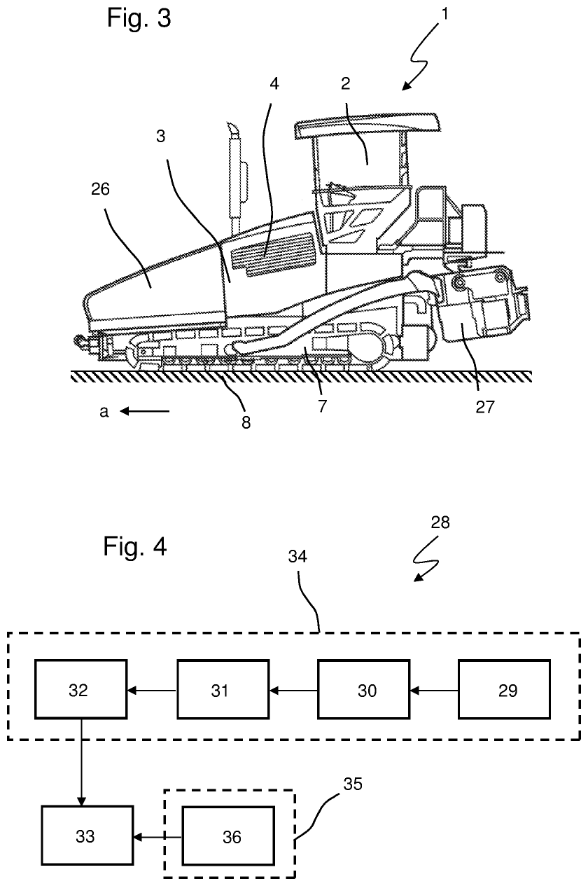

FIG. 3 shows a third construction machine 1, which is configured as a road paver. The construction machine 1 comprises an operator platform 2 arranged on the machine frame 3, a drive motor 4, traveling devices, i.e. the traveling mechanism 7, which is in this embodiment example configured as a crawler track, and a receiving bunker or bunker 26. Furthermore, a liftable and lowerable paving screed 27 is provided at the rear end of the construction machine 1 for compacting and smoothing paving material.

The listing of the specific types of construction machines mentioned in FIGS. 1 to 3 is merely exemplary for the construction machines that may be contemplated here. The invention also covers other construction machines, in particular dump trucks, more specifically articulated dump trucks, crawlers, graders, road milling machines, recyclers, stabilizers, excavators, wheeled loaders, etc.

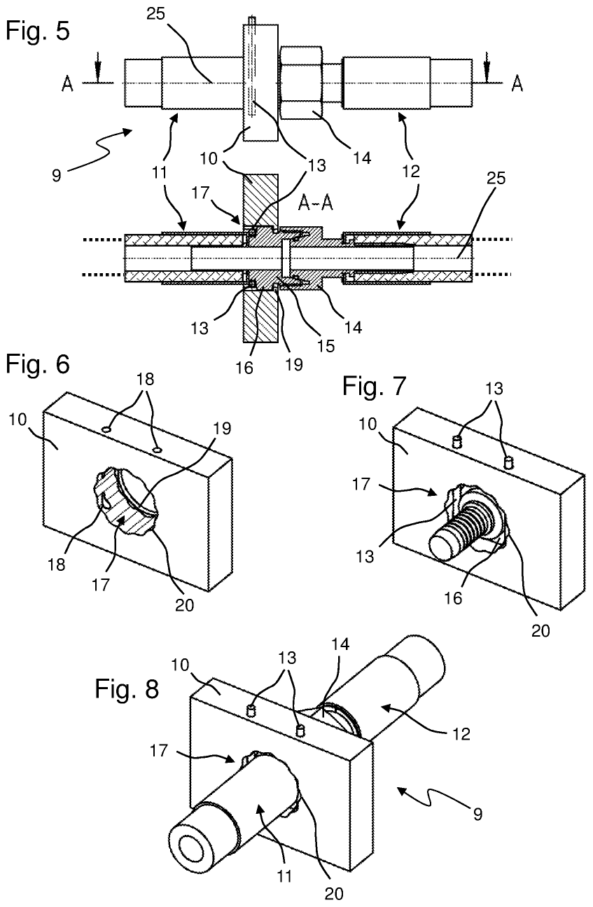

FIG. 4 schematically illustrates a first assembly group 34 and a second assembly group 35 for carrying out the method 28 for producing a hydraulic hose coupling of a construction machine (see FIG. 1 to FIG. 3). In particular, the following steps are performed in the first assembly group 34:
a) attaching 29 a fitting to a first hose end 11 (see FIG. 5) of a first hydraulic hose;
b) inserting 30 the fitting of the first hose end 11 into a fitting receptacle 17 of a fitting securing device 9 (see FIG. 5);
c) securing 31 the fitting of the first hose end 11 against rotation in the fitting receptacle 17 of the fitting securing device 9 (see FIG. 5); and
d) securing 32 the fitting of the first hose end 11 against axial movement in the fitting receptacle 17 of the fitting securing device 9 with respect to a flow axis 25 of the hydraulic hose coupling (see FIG. 5).

In the second assembly group 35, the step of attaching 36 a fitting complementary to the fitting of the first hose end 11 to a second hose end 12 of a second hydraulic hose (see FIG. 5) is performed completely separately in time and place from steps 29 to 32. After the above steps are performed, a further step of connecting 33 the fitting of the first hose end 11 directly to the fitting of the second hose end 12 (see FIG. 5) is performed, for example when the pre-assembly group obtained by steps 29 to 32 is connected to the remaining construction machine in step 33. The advantage illustrated in FIG. 4 consists in the fact that merely one single hose connection is necessary for producing a fluid-conducting connection between the two hoses and thus there is only one connection point to be sealed.

FIG. 5 shows a side view (top part) as well as a cross-sectional view (bottom part) taken along line A-A in a top view (arrows) of a fitting securing device 9 according to an embodiment of the invention, which is used for connecting hydraulic hoses used in construction machines such as those described exemplarily with respect to FIG. 1 to FIG. 3, wherein the fitting securing device 9 serves to facilitate the assembly and securing of the hydraulic hose coupling. For this purpose, the fitting securing device 9 includes a holding device 10 including a fitting receptacle 17 which serves to receive a fitting of a first hose end 11 of a first hydraulic hose. The fitting receptacle 17 penetrates the holding device 10 such that a fitting of a second hose end 12 of a second hydraulic hose can be coupled—for example screwed—directly to the fitting of the first hose end 11 secured in the fitting receptacle 17. For this purpose, a suitable passage opening may be provided in the holding device 10, as is shown in more detail, for example, in FIGS. 6 to 8.

The holding device 10 may be fixed in a stationary position in the respective construction machine, for example by a direct or indirect connection to the machine frame, in order to enable a good mountability of the first hose end or the corresponding fitting on/in the holding device 10 on the one hand and to enable the connection of the second hose end or the corresponding fitting to the first fitting on the other hand.

The fitting securing device 9 further includes an axial securing device which prevents displacement of the fitting of the first hose end 11 along at least one direction of the flow axis 25 in the fitting receptacle 17. The axial securing device may include a detachable axial stop 13 against which the fitting of the first hose end 11 rests in the fitting receptacle 17 and which prevents displacement of the fitting of the first hose end 11 along a direction of the flow axis 25 in the fitting receptacle 17.

The detachable axial stop 13, which will be described in more detail in connection with FIGS. 6 to 8, may include a bolt which prevents movement of the fitting of the first hose end 11 in a form-locking manner in a direction of the flow axis 25. The detachable axial stop 13 may also comprise two projections with which the detachable axial stop 13 engages around the fitting of the first hose end 11 at least partially, in particular at least half the circumference of the fitting.

In the embodiment illustrated here, the axial securing device is formed both by the axial stop formed with the holding device 10 and by an axial stop 19 formed integrally with a base block of the holding device 10, which also prevents displacement of the fitting of the first hose end 11 along a direction of the flow axis 25 in the fitting receptacle 17 which is different from the direction in which the detachable axial stop 13 counteracts displacement.

A holding collar 16 provided on the fitting of the first hose end 11 and a nipple 15 or projection rising from the holding collar 16 are received in the holding device 10. Provided on the nipple or projection 15 is an external thread onto which the threaded securing device 14 provided on the second hose end 12 can be screwed. For this purpose, the nipple or projection 15 projects in the flow direction beyond the the base block of the holding device 10.

FIG. 6 shows a perspective view of the holding device 10 according to the discussion of the invention in connection with FIG. 5. As is illustrated, the holding block of the holding device 10 is provided with an anti-rotation device 20 which prevents rotation of the fitting of the first hose end 11 about the flow axis 25 in the fitting receptacle 17. The anti-rotation device 20 is obtained by the fact that the axial securing device receptacle 18 of the fitting receptacle 17 is not smooth or circular on the inner wall but includes recesses extending along the flow axis 25 and engaged in the radial direction by the fitting of the first hose end. This achieves a form lock in the direction of rotation in relation to the flow axis 25, so that the fitting of the first hose end in the holding device cannot rotate about the flow axis 25.

As can be further seen here, the axial securing device receptacle 18 comprises two through bores or fixing bores into which the detachable axial stop 13 (see FIG. 7 and FIG. 8) in the form of two pins or bolts can be inserted perpendicularly to the flow axis 25 to produce a detachable axial lock.

FIG. 7 shows a perspective view of the holding device 10 illustrated in FIG. 6 with the fitting of the first hose end inserted. As can be further seen, the two pins are inserted into the through bores, so that the detachable axial stop 13 is formed which engages behind the holding collar 16 of the fitting of the first hose end 11 located in the fitting receptacle 17 (see FIG. 8) and secures it in a direction of the flow axis 25 in a form-locking manner (see FIG. 8).

FIG. 8 shows another perspective view of the holding device 10 illustrated in FIG. 6 wherein here the first hose end 11 and the second hose end 12 are accommodated therein and secured such that they cannot be displaced axially and radially.

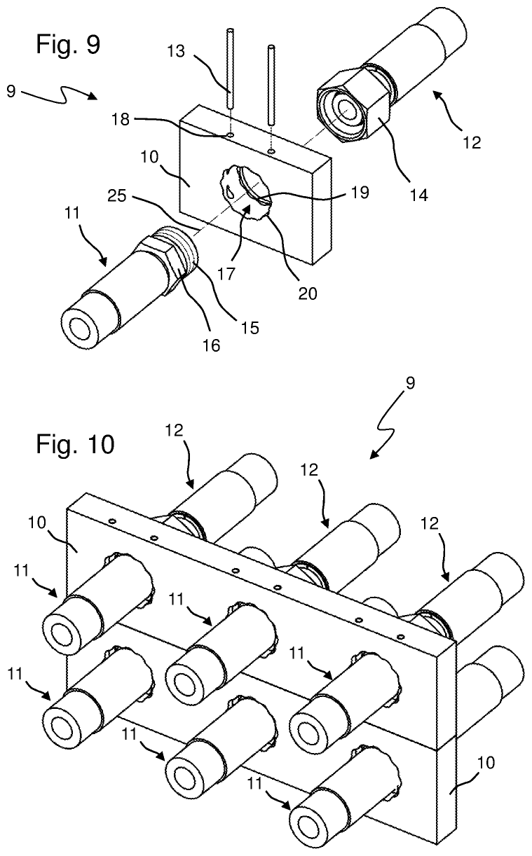

FIG. 9 now concerns an exploded view of the fitting securing device 9 as already discussed with respect to FIGS. 5 to 8. As can be seen here, the fitting securing device comprises the holding device 10 with the anti-rotation device 20 in the fitting receptacle 17 described above which, as also described above, is formed in the holding device 10 by at least one recess in the direction of the flow axis 25, and the axial securing device with the axial securing device receptacle 18 into which the detachable axial stop can be inserted in the form of two through bores formed in the holding device 10 perpendicular to the flow axis 25. In this manner, the second hose end 12 provided with the threaded securing device 14 can be inserted from one side into the holding device 10 or brought up to the holding device 10, and the first hose end 11, on which the holding collar 16, here formed with a hexagonal circumference, and the projection or nipple 15 provided with an external thread are provided, can be inserted into the holding device 10 from the opposite side. Thus, in this embodiment, only one of the two fittings, i.e. the fitting of the first hose end, is fixed in the holding device 10. The first and second fittings can be mounted on the hose ends separately and are then connected directly to one another. Also visible here is the one-piece axial stop 19 formed in the fitting receptacle 17, which is ring-shaped at the entrance opening into which the second hose end 12 is inserted, thus reducing the diameter of the fitting receptacle 17 at the entrance opening.

FIG. 10 shows a perspective view of a fitting securing device 9 according to another embodiment, which is based on the basic structure of the holding device 10 shown in FIGS. 5 to 9. In this case, however, the holding device 10 is configured to receive and secure multiple hydraulic hose couplings simultaneously, the flow axes 25 of the respective hydraulic hose couplings being arranged parallel to one another. In the embodiment shown here, three first hose ends 11 and three second hose ends 12 can be coupled together in the holding device 10. Furthermore, two holding devices 10 are provided here which are configured complementary in a form-locking manner, wherein the holding devices 10 are attached to one another such that the flow axes 25 of all hydraulic hose couplings are arranged parallel to one another. Compared to the embodiment example of FIGS. 5 to 9, the described holding device 10 has thus been multiplied in one holding block.

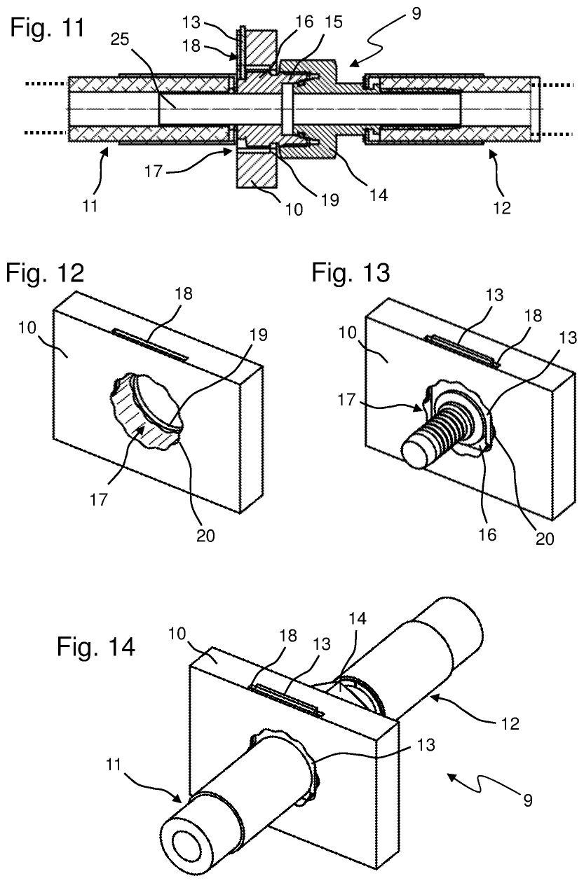

FIG. 11 shows a cross-sectional view of a fitting securing device 9 according to another embodiment which is similar to the variant described in connection with FIGS. 5 to 8, so that essentially only the existing differences will be discussed below while reference is otherwise made to the previous explanations. The difference here consists in particular in the configuration of the detachable axial stop 13, which will be described in more detail in connection with FIGS. 12 to 15.

FIG. 12 is a perspective view of a holding device 10 according to the embodiment illustrated in FIG. 11. As already mentioned, the detachable axial stop 13 here differs from the previously described embodiments, in particular in that, for detachable axial securing of the fitting of the first hose end 11, which can be inserted into the holding device 10, not two through bores running perpendicular to the flow axis are provided in the holding device 10 but instead an elongated slot is in this case provided as axial securing device receptacle 18. FIG. 13 shows another perspective view of the holding device 10 illustrated in FIG. 12. Here, the detachable axial stop 13 is inserted into the axial securing device receptacle 18 configured as an elongated slot. The detachable axial stop is in this case a planar securing element inserted into this slot perpendicular to the flow axis 25 and partially engaging around the fitting of the first hose end 10 inserted into the holding device 10.

FIG. 14 is yet another perspective view of the holding device 10 illustrated in FIG. 12. As can be seen here, the fitting securing device 9 is assembled by inserting and securing the fitting of the first hose end 11 in the fitting receptacle 17 coming into the holding device 10 from one side and placing the fitting of the second hose end 12 on the projection 15 of the fitting of the first hose end 11 coming from the opposite side.

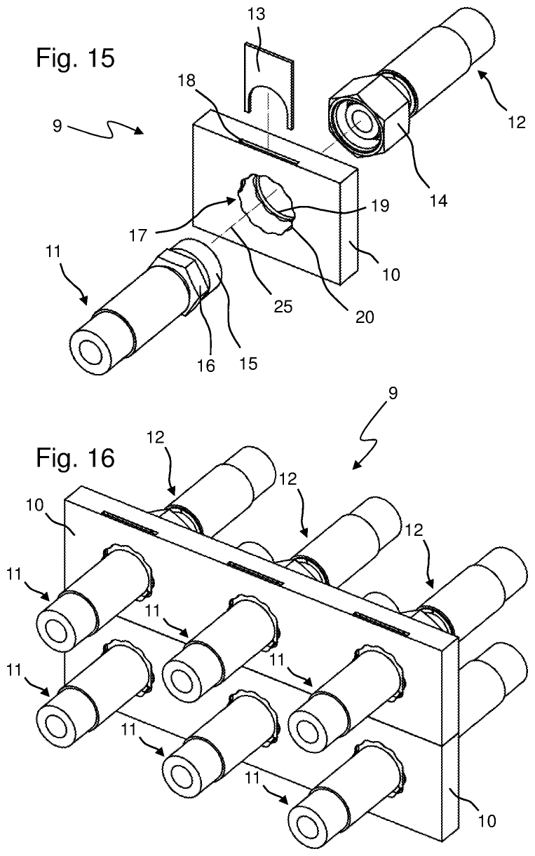

FIG. 15 shows an exploded view of the fitting securing device according to the embodiment illustrated in FIG. 11, which is essentially configured like the embodiment described in connection with FIG. 9. As can be seen here, the detachable axial stop differs, which here is not in the form of pins but in the form of the plate-shaped axial stop 13, which is provided at a lower end with the semicircular recess, and which can be passed through the slot of the axial securing device receptacle 18, so that the fitting of the first hose end 11 in the area of the projection 16 comes into engagement in the direction of the flow axis 25.

FIG. 16 is a perspective view of a fitting securing device 9 according to another embodiment. As can be seen, the structure and arrangement of the in this case two fitting securing devices 9 attached to one another essentially corresponds to the embodiment described in connection with FIGS. 11 to 15. In contrast to the latter, the holding device 10 is provided with receptacles for multiple first hose ends 11.

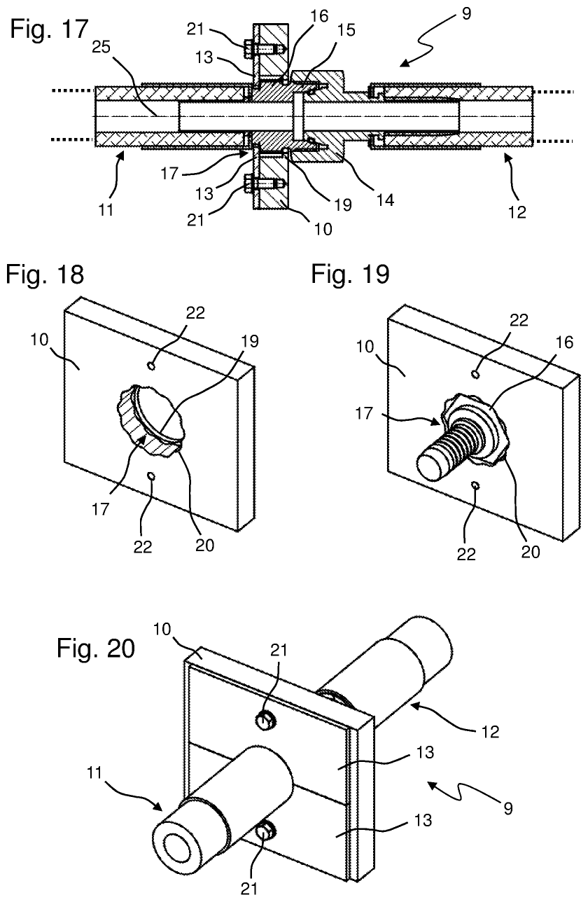

FIG. 17 shows a fitting securing device 9 according to another embodiment of the invention, which in turn differs from the previously described embodiment with regard to the design of the detachable axial stop 13. The other components of the fitting securing device 9 are configured as in the previously described embodiments and are therefore not discussed again here. As can be seen here, the detachable axial stop 13 is configured as a plate-like element which is fastened to the holding device 10 using fastening devices 21, in this case using screws. The screws engage corresponding bores provided in the holding device 10, which are described further in connection with FIG. 18.

FIG. 18 is a perspective view of a holding device 10 according to the embodiment illustrated in FIG. 17. As can be seen here, the holding device 10 is provided with the bores 22 extending essentially parallel to the flow axis 25, wherein a first bore 22 is provided above the fitting receptacle 17 and a second bore 22 is provided below the fitting receptacle 17.

FIG. 19 is another perspective view of the holding device 10 illustrated in FIG. 18 with the holding collar 16 already arranged non-rotatably in the fitting receptacle 17.

FIG. 20 shows yet another perspective view of the holding device 10 illustrated in FIG. 18, in which the first hose end 11 is secured therein by the screwed-on plate-shaped axial stop 13, to which end fastening devices 21 configured as screws are detachably connected to the holding block of the holding device 10. The axial stop 13 is in this case configured as a two-part plate-like element. An upper half of the plate-like element with a semi-circular recess engages around the first hose end 11 from above, and a lower half of the plate-like element, which is likewise formed with a semi-circular recess, engages around the first hose end 11 from below. Both halves of the plate-like element of the detachable axial stop 13 are detachably secured to the holding device 10 using a respective fastening device 21, i.e. screws.

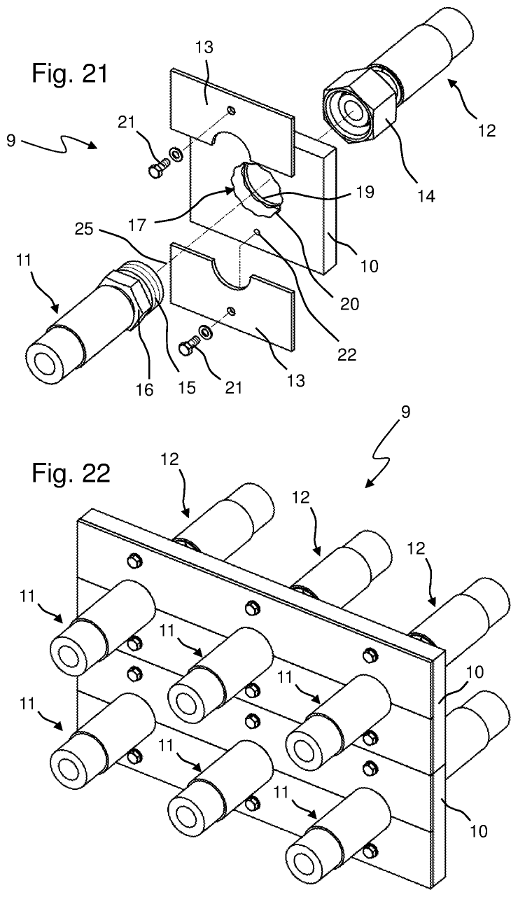

FIG. 21 shows an exploded view of the fitting securing device 9 according to the embodiment illustrated in FIGS. 17 to 20, which includes the split plate-like element described in connection with FIG. 20 as the detachable axial stop 13.

FIG. 22 is a perspective view of a fitting securing device 9 according to another embodiment in which two holding devices 10 with in each case multiple (three) fitting receptacles 17 are provided which are attached to one another.

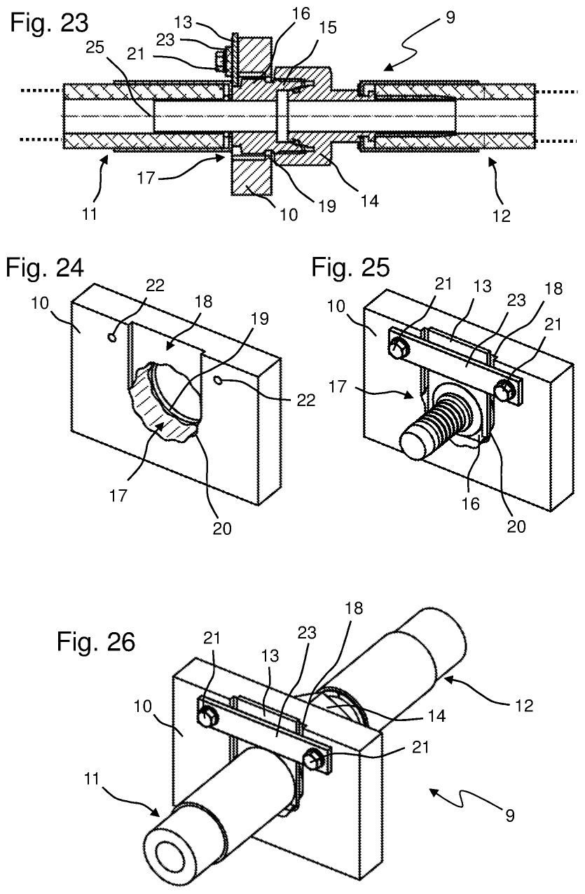

FIG. 23 shows a fitting securing device 9 according to another embodiment of the invention, which in turn differs from the previously described embodiment with regard to the design of the detachable axial stop 13. The other components of the fitting securing device 9 are configured as in the previously described embodiments and are therefore not discussed again here. As can be seen here, as in the embodiments described in FIG. 17 to FIG. 22, the detachable axial stop 13 is configured as a plate-like element which is fastened to the holding device 10 using fastening devices 21, in this case using screws. The screws engage corresponding bores 22 provided in the holding device 10, which are described further in connection with FIG. 24.

FIG. 24 is a perspective view of a holding device 10 according to the embodiment illustrated in FIG. 23. As can be seen here, the holding device 10 is provided with the bores 22 having respective longitudinal axes extending essentially parallel to the flow axis 25. In contrast to the embodiments illustrated in FIG. 17 to FIG. 22, however, the first bore 22 is in this case provided above the fitting receptacle 17 but offset to the left, and a second bore 22 is provided at the same height as the first bore 22 but offset to the right. The plate-like detachable axial stop 13 is in this case configured as a single piece and includes an essentially U-shaped recess extending downward from the upper edge of the axial stop 13.

FIG. 25 is another perspective view of the holding device 10 illustrated in FIG. 24 with the holding collar 16 already arranged non-rotatably in the fitting receptacle 17. The releasable axial securing by the detachable axial stop 13 consists in the fact that a securing holder 23 configured as a bracket-like element is provided here which is fastened to the holding device 10 by means of the fastening devices 21, in particular by means of screws inserted into the bores 22, and which holds the detachable axial stop 13 in the axial securing device receptacle 18 in a form-locking manner in the direction of the flow axis 25.

FIG. 26 is yet another perspective view of the holding device 10 illustrated in FIG. 24 with the fitting of the first hose end 11 secured therein. The axial securing, which is also detachable using the fastening device 21 configured as screws, is achieved by the plate-like element with the securing holder 23 as detachable axial stop 13 as described above in connection with FIG. 23 to FIG. 25.

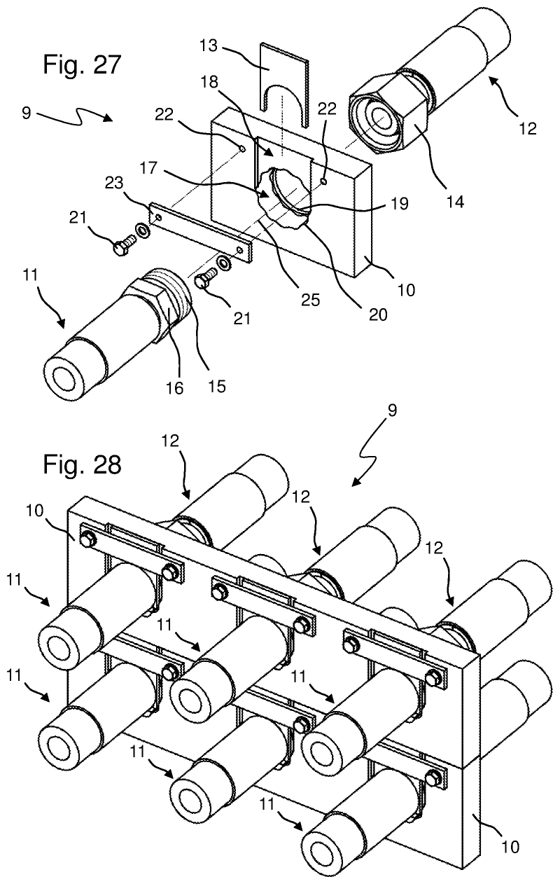

FIG. 27 is an exploded view of the fitting securing device 9 according to the embodiment illustrated in FIG. 24, which includes as the detachable axial stop 13 the plate-like element with the securing holder 23 described in connection with FIG. 23 to FIG. 26, which can be fastened to the holding device 10 using the fastening devices 21 configured as screws to engage and axially secure the first hose end 11.

FIG. 28 is a perspective view of a fitting securing device 9 according to another embodiment in which two holding devices 10 with in each case three fitting receptacles 17 are provided which are attached to one another. The first hose ends 11 are secured in the respective fitting receptacles in a non-rotatable and axially non-displaceable manner, wherein the detachable stop 13, corresponding to the plate-like element illustrated in FIG. 23 to FIG. 27, is configured with the securing holder 23, however in this case three U-shaped recesses are respectively provided for engaging the first hose ends 11.

What is claimed is:

1-18. (canceled)

19. A fitting securing device to facilitate assembly and securing of at least one hydraulic hose coupling of a construction machine, the fitting securing device comprising:
at least one holding device comprising a fitting receptacle to receive a fitting of a first hose end;
the holding device including an anti-rotation device, which prevents rotation of the fitting of the first hose end in the fitting receptacle about a flow axis;
an axial securing device, which prevents displacement of the fitting of the first hose end in the fitting receptacle along at least one direction of the flow axis; and
the fitting receptacle penetrating the holding device such that a fitting of a second hose end is coupleable directly to the fitting of the first hose end in the fitting receptacle.

20. The fitting securing device according to claim 19, wherein the fitting receptacle is configured as an opening completely penetrating the holding device; and
wherein the anti-rotation device is configured as an edge defining the opening in a radial direction of the flow axis, the edge being polygonal or corrugated and configured to engage the fitting of the first hose end in a form-locking manner at least such that rotation of the fitting of the first hose end in the fitting receptacle is prevented.

21. The fitting securing device according to claim 19, wherein the axial securing device includes an axial stop formed integrally with the holding device against which the fitting of the first hose end rests in the fitting receptacle and which prevents displacement of the fitting of the first hose end in the fitting receptacle along the at least one direction of the flow axis.

22. The fitting securing device according to claim 21, wherein the axial stop is configured as a constriction of the fitting receptacle along the flow axis.

23. The fitting securing device according to claim 22, wherein the constriction of the fitting receptacle along the flow axis comprises at least one projection.

24. The fitting securing device according to claim 23, wherein the at least one projection at least partially surrounds an inside of the fitting receptable.

25. The fitting securing device according to claim 19, wherein the axial securing device includes at least one detachable axial stop against which the fitting of the first hose end rests in the fitting receptacle and which prevents displacement of the fitting of the first hose end in the fitting receptacle along the at least one direction of the flow axis.

26. The fitting securing device according to claim 25, wherein the holding device includes an axial securing device receptacle which extends continuously from an outside of the holding device into the fitting receptacle, wherein the detachable axial stop is insertable into the axial securing device receptacle such that the detachable axial stop at least partially engages behind a holding collar of the fitting of the first hose end located in the fitting receptacle and secures the fitting of the first hose end along the at least one direction of the flow axis in a form-locking manner.

27. The fitting securing device according to claim 25, wherein the detachable axial stop comprises a bolt which prevents movement of the fitting of the first hose end in a form-locking manner along the at least one direction of the flow axis.

28. The fitting securing device according to claim 25, wherein the detachable axial stop comprises two projections with which the detachable axial stop engages at least partially around the fitting of the first hose end.

29. The fitting securing device according to claim 25, wherein the holding device includes a bore to which the detachable axial stop is fastenable with a fastening device.

30. The fitting securing device according to claim 26, wherein the axial securing device receptacle is configured as a recess along the flow axis in the holding device, and that a securing holder is provided which is fastened to the holding device and holds the detachable axial stop in the axial securing device receptacle in a form-locking manner along the at least one direction of the flow axis.

31. The fitting securing device according to claim 25, wherein two detachable axial stops are provided against which the fitting of the first hose end rests in the fitting receptacle and which prevents displacement of the fitting of the first hose end in the fitting receptacle along the at least one direction of the flow axis.

32. The fitting securing device according to claim 19, wherein the axial securing device includes an integral axial stop, formed integrally with the holding device, and a detachable axial stop, which is detachable from the holding device, wherein the integral and detachable axial stops prevent the fitting of the first hose end from being displaced in the fitting receptacle along opposite directions of the flow axis.

33. The fitting securing device according to claim 19, wherein the holding device is configured to receive and secure multiple hydraulic hose couplings simultaneously, with flow axes of the respective hydraulic hose couplings arranged parallel to one another.

34. The fitting securing device according to claim 19, further comprising multiple holding devices which are configured complementary in a form-locking manner and are fastenable to one another.

35. The fitting securing device according to claim 19, wherein the fitting securing device is disposed on a construction machine.

36. The fitting securing device according to claim 35, wherein the construction machine is a ground compactor, a landfill compactor or a road paver.

37. A method for producing a hydraulic hose coupling of a construction machine, comprising:
attaching a fitting to a first hose end of a first hydraulic hose;
inserting the fitting of the first hose end into a fitting receptacle of a fitting securing device;
securing the fitting of the first hose end against rotation in the fitting receptacle of the fitting securing device;
securing the fitting of the first hose end against axial movement in the fitting receptacle of the fitting securing device with respect to a flow axis of the hydraulic hose coupling;
attaching a fitting complementary to the fitting of the first hose end to a second hose end of a second hydraulic hose; and
connecting the fitting of the first hose end directly to the fitting of the second hose end.

38. The method according to claim 37, wherein:
attaching a fitting to a first hose end of a first hydraulic hose, inserting the fitting of the first hose end into a fitting receptacle of a fitting securing device, securing the fitting of the first hose end against rotation in the fitting receptacle of the fitting securing device, and securing the fitting of the first hose end against axial movement in the fitting receptacle of the fitting securing device with respect to a flow axis of the hydraulic hose coupling are performed on a first assembly group;
attaching a fitting complementary to the fitting of the first hose end to a second hose end of a second hydraulic hose is performed on a second assembly group; and
connecting the fitting of the first hose end directly to the fitting of the second hose end is performed while connecting the first assembly group and the second assembly group.
